(19) United States
(12) Patent Application Publication
(10) Pub. No.: US 2020/0136816 A1
(43) Pub. Date: Apr. 30, 2020

(54) AUTHENTICATION USING ASYMMETRIC CRYPTOGRAPHY KEY PAIRS

(71) Applicant: Hewlett Packard Enterprise Development LP, Houston, TX (US)

(72) Inventors: Bhagya Prasad Nittur, Santa Clara, CA (US); Pattabhi Attaluri, Santa Clara, CA (US)

(21) Appl. No.: 16/173,544

(22) Filed: Oct. 29, 2018

(51) Int. Cl. H04L 9/08; H04L 9/32; H04L 29/06

(52) U.S. Cl. CPC H04L 9/0825; H04L 63/083; H04L 9/3247; H04L 9/3297

(57) ABSTRACT

An example authentication server system comprising: a processor; and a memory resource storing machine readable instructions executable by the processor to: receive an input from a device indicating a request to log into the system; verify the input from the device using an asymmetric cryptography key pair; deny access to the device in response to the input failing to correspond to the asymmetric cryptography key pair; and inactivate an account of the device based on a number of attempt failures exceeding a failure threshold.

### BACKGROUND

Authentication applications can rely on one or more encryption procedures. In symmetric key procedures, the sender and receiver share a common key which is used for both encryption and decryption.

### BRIEF DESCRIPTION OF THE DRAWINGS

FIG. 1 illustrates an example authentication server system consistent with the present disclosure.

FIG. 2 illustrates an example of a non-transitory machine readable medium consistent with the present disclosure.

FIG. 3 illustrates a diagram of an example method consistent with the present disclosure.

FIG. 4 illustrates an example of a non-transitory machine readable medium consistent with the present disclosure

FIG. 5 illustrates an example flowchart of a method for authentication using an asymmetric cryptography key pair consistent with the present disclosure.

### DETAILED DESCRIPTION

Asymmetric cryptography authentication is a means to authenticate a device. For example, asymmetric cryptography authentication can be used by a device to login to a server. In some examples, secure shell (SSH) protocol can use asymmetric cryptography authentication to provide a secure way of accessing a system. As used herein the term “authentication” refers to a process or action of verifying the identity of a device, user and/or process. As used herein, the term “secured shell” (SSH) refers to a cryptographic network protocol for operating network services securely over an unsecured network. In some examples, SSH can include remote administration protocol that allows devices to control and modify their remote devices over a network. SSH protocol can provide a secure channel over an unsecured network in a client-server architecture, connecting a device application with a server. SSH protocol can use asymmetric cryptography to authenticate a remote computer and allow it to authenticate the device.

In some previous authentication approaches, for example, a device can be authenticated by entering a correct password. A single method to demonstrate the device possesses the password is to provide the server with a response from the device indicating the password. However, in response to the server being hacked, an attacker may learn the device's password.

In some previous approaches, when a device fails to authenticate using a password authentication method, the device may be blocked from logging in by blacklisting the device's Internet Protocol (IP) address. Such approaches use log-based intrusion prevention security tool for SSH servers. These approaches inspect the logs for SSH login failure attempts and ban IP addresses after a certain number of failed login attempts. As connection attempts from specific IP addresses get banned, hackers can use other hosts to attack and enter the system, and legitimate logins may be disallowed. Additionally, such previous approaches do not provide the ability to lock an SSH server after a consecutive failed attempt, without falling back to a password based authentication, in addition to having the lockout in effect for a period of time. As referred herein, the term “period of time” refers to an interval of time during which a server and/or a system is locked out.

Accordingly, the present disclosure describes an authentication system and method of using asymmetric cryptography key pair to authenticate an SSH channel on the server side. The present disclosure also describes SSH channel authentication without requiring a password based authentication.

As described herein, an asymmetric cryptography key pair can include a public key and a private key to encrypt and decrypt data. For instance, the public key can be known by servers, systems, authorized and unauthorized devices. The private key can be kept secret from unauthorized devices, systems and servers. The private key can be made known to authorized devices (e.g. user device). In some examples, the private key can be used to generate digital signatures. As used herein, the term digital signature refers to a technique used to validate the authenticity and integrity of a message, software and/or a digital document. For example, a digital signature created using the private key may not be generated by, devices, or systems that do not possess that private key. However, devices or systems with a public key can verify that a particular digital signature is authentic.

In some examples, the public-private key pair can be automatically generated to encrypt a network connection. As described herein, the term “automatically” refers to generating an outcome (e.g., generating public-private key pair, digital signatures, starting an authentication agent) without input (e.g., passphrase, digital signature) from a device and/or a user. In some examples, a public-private key pair can be generated manually to perform the authentication, allowing devices (e.g., user devices) or programs to log in without having to provide a password. In such examples, devices can produce a matching pair of different keys (public and private). In some examples, the public and private key pairs for SSH access can be generated via a SSH-keygen command. As described herein, the term ‘SSH-keygen’ refers to a command that generates authentication key pairs for SSH based on public key methods (e.g., such as Rivest-Shamir-Adleman (RSA), Digital Signature Algorithm (DSA), Elliptic Curve Digital Signature Algorithm (ECDSA). The public key can be stored on systems that allow access to the owner of the matching private key (the owner keeps the private key secret). While authentication is based on the private key, the key itself cannot be transferred through the network during authentication. SSH can verify whether the same device offering the public key also owns the matching private key. SSH can also verify unknown public keys.

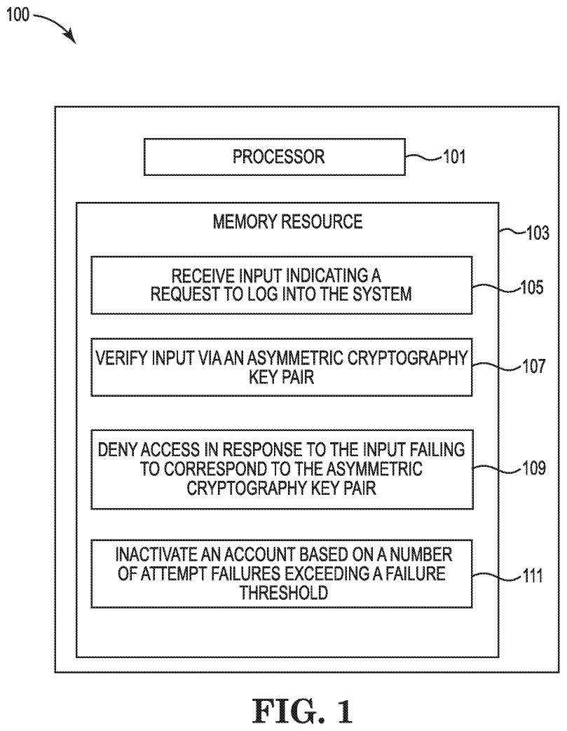

FIG. 1 illustrates an example authentication server system 100 consistent with the present disclosure. Authentication server system 100 can include a processor 101 and a memory resource 103. The memory resource 103 of the authentication server system 100 can be used to store instructions 105,107,109 and 111 executable by the processor 101 to perform operations described herein in relation to FIG. 1

The processor 101 can, for example, be in the form of a central processing unit (CPU), a semiconductor-based microprocessor, a digital signal processor (DSP) such as a digital image processing unit, other hardware devices or processing elements suitable to retrieve and execute instructions stored in a storage medium, or suitable combinations thereof. The processor, for example, include single or multiple cores on a chip, multiple cores across multiple chips, multiple cores across multiple devices, or suitable combinations thereof. The memory resource 103, for example, can be any type of volatile or non-volatile memory or storage, such as random-access memory (RAM), flash memory, read-only memory (ROM), storage volumes, a hard disk, or a combination thereof. The memory resource 103 can be used to store instructions such as instructions 103,105,107,109 and 111, executable by the processor 101. When executed by the processor 101, the instructions can cause the authentication server system 100 to perform specific tasks and/or functions, as described herein.

The memory resource 103 can include instruction 105, executable by the processor 101, to receive an input from a device indicating a request to log into the authentication server system 100. In some examples, input from the device can be a digital signature, or a passphrase entered by the device. In some examples, input by the device can be encrypted data. As described herein, the term “encrypted data” refers to data that can be converted from a readable form to an encoded version that can be decoded by another entity if they have access to a decryption key. In some examples, input can be decrypted data entered by the device. As described herein, the term “decrypted data” refers to transformed data that has been rendered unreadable through encryption back to its unencrypted form.

In some examples, the input from the device can be decrypted using an authentication agent. An authentication agent can be a separate entity which can hold decrypted private keys and generate digital signatures on request. The request can be sent by the device and/or an SSH server. In some examples, when an account is accessed by a device , the device's private key is loaded into the server. For the remainder of the device's session, the device can automatically start the authentication agent to generate digital signatures. As the device exits the account, the authentication agent can shut down automatically without storing the device's decrypted private key on the server disk. In some examples, the authentication agent can decrypt the private keys.

The memory resource 103 can include instruction 107, executable by the processor 101, to verify the input from the device using an asymmetric cryptography key pair. As described herein, the term “asymmetric cryptography key pair” refers to a public key and a private key to encrypt and decrypt data. The keys include data indicating numerical values that have been paired together but are not identical. One key in the asymmetric cryptography key pair can be shared with device other than the device; it is referred to as the public key. The other key in the asymmetric cryptography key pair is not shared with devices; it is referred to as the private key. Either of the public and/or private keys can be used to encrypt a message; the opposite key from the private and/or private key used to encrypt the message can be used for decryption. In some examples, the authentication server system 100 can verify the input from the device by verifying that a device that possesses the public key has sent an encrypted message, and that the private key paired with the public key can decrypt the message encrypted with the public key.

In some examples, by using an asymmetric cryptography key pair, a device can combine a message with a private key to create a short digital signature within the message. In such examples, the device with the corresponding public key can combine a message to read the message within the digital signature of the private key. The known public key can verify whether the digital signature is valid by verifying that the private key was made by the owner and/or generator of the corresponding private key. In some examples, changing the message, even replacing a single letter, symbol, and/or number, can cause verification to fail. In response to the verification failing, the authentication server system 100 can deny access to the device. In some examples, a public key can include a public key encryption in which a message is encrypted with a recipient's public key. In some examples, only a public key can be used to verify the input. For example, system 100 can verify input using the public key without an additional authentication verification. In some examples, additional authentication verification can include passphrase verification, digital signature verification, biometric verification.

In some examples, the public key of the asymmetric cryptography key pair can be copied to the authentication server system 100. In some examples, the public key of the asymmetric cryptography key pair can include a fingerprint value. The finger print value can be derived cryptographically from the public key value. In some examples the fingerprint value can be a short key with smaller data set that can identify a longer public key. The snippets or short data set the fingerprint value comprises can be cryptographically secure.

The memory resource 103 can include instruction 109, executable by the processor 101, to deny access to the device in response to the input failing to correspond to the asymmetric cryptography key pair. For example, authentication server system 100 can verify that the public key holder of the paired private key of an asymmetric cryptography key pair sent an input. The authentication server system 100 can then verify whether the paired private key can decrypt the message encrypted with the public key. In response to the private key corresponding to the paired public key, the authentication server system 100 can grant the device access to the account. In some examples, the authentication server system 100 can deny access in response to the private key not corresponding to the public key. In some examples, denying access can restrict the device from accessing a server and/or a system.

The memory resource 103 can include instruction 111, executable by the processor 101, to inactivate an account of the device based on a number of attempt failures exceeding a failure threshold. As described herein, a failure threshold refers to a threshold value (e.g., quantity) of failure attempts at which the authentication server system 100 inactivates an account. As described herein, inactivation refers to the account being put in a locked and/or inoperative state.

In some examples, the failure threshold can be set to ten consecutive failures. In some examples, the failure threshold can be adjusted manually by a device and/or a user. As described herein, the term “manual adjustment” refers to adjusting the failure threshold of a device capable of receiving inputs (e.g., passphrase, digital signature) In some examples, the failure threshold can be adjusted automatically. In some examples, the failure threshold can be determined by monitoring failed events and marking the failed events with a failed event stamp. In some examples, the quantity of attempted failures exceeding a failure threshold can trigger password based authentication. In some examples, the account can be inactive for a threshold period of time. In some examples, the threshold period of time can be fifteen minutes.

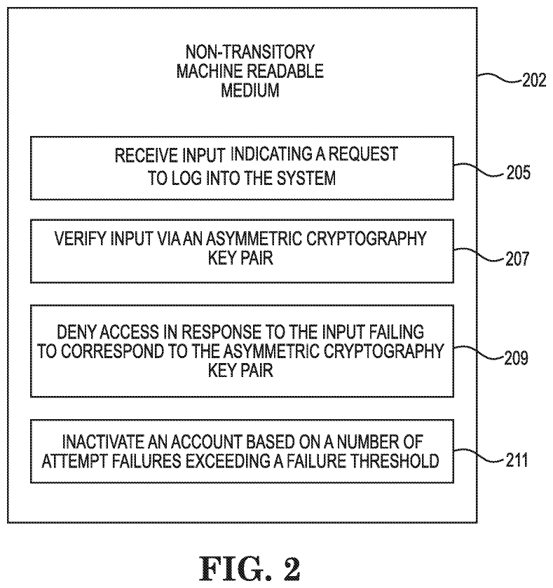

FIG. 2 illustrates an example of a non-transitory machine readable medium 202 consistent with the present disclosure. The non-transitory machine readable medium 202 can execute instructions 205, 207, 209, and 211 using a processor (such as processor 101 in FIG. 1). The processor can execute instructions stored on the non-transitory machine readable medium 202. The non-transitory machine readable medium 202 can be any type of volatile or non-volatile memory or storage, such as random access memory (RAM), flash memory, read-only memory (ROM), storage volumes, hard disk, or a combination thereof

The example medium 202 can store instructions 205 executable by a processor to receive an input from a device indicating a request to log into a system (such as authentication server system 100, as described in FIG. 1). In some examples, the input from the device can be a digital signature, or a passphrase entered by the device. In some examples, the input from the device can be encrypted data. In some examples, the input from the device can be decrypted using an authentication agent.

In some examples, the authentication agent can be instructions stored on a different device which can hold decrypted private keys and generate digital signatures on request from the device and/or a server. In some examples, when an account is accessed by the device, the private key of the device can be loaded into the server. For the remainder of the session, the device can automatically start the authentication agent to generate digital signatures. For example, the device can start the authentication agent without entering an input (e.g. passphrase). As the device exits the account, the authentication agent can shut down automatically without storing the device's decrypted private key on the server disk. In some examples, the authentication agent can decrypt the private key.

The example medium 202 can store instructions 207 executable by a processor to verify the input from the device using an asymmetric cryptography key pair. As described herein, the public key in the asymmetric cryptography key pair can be shared with servers, systems, authorized devices (e.g. user device) and unauthorized devices. The private key of the asymmetric cryptography key may not be shared with unauthorized devices. Either of the public and/or private keys can be used to encrypt a message; the opposite key from the public and/or private key used to encrypt the message can be used for decryption. In some examples, an authentication server system, such as the authentication server system 100, can verify the input from the device by verifying that a holder of the public key sent an encrypted message, and that a paired private key can decrypt the message encrypted with a public key.

The example medium 202 can store instructions 209 executable by a processor to deny the device's access in response to the input failing to correspond to the asymmetric cryptography key pair. In some examples, the example medium 202 can store instructions executable by a processor to verify that the public key holder of the paired private key of an asymmetric cryptography key pair sent an input. The example medium 202 can store instructions executable by a processor to verify whether the paired private key can decrypt the message encrypted with the public key. In some examples, the medium 202 can store instructions executable by the processor to grant access in response to the private key corresponding to the paired public key. In some examples, the medium 202 can store instruction to deny access in response to the private key not corresponding to the public key.

The example medium 202 can store instructions 211 executable by a processor to inactivate the device account based on the quantity of attempted failures exceeding a failure threshold. In some examples, the failure threshold can be set to five consecutive failures. In some examples, the failure threshold can be adjusted manually by a device. For example, a user can set the failure threshold to seven consecutive failures instead of five consecutive failures. In some examples, the failure threshold can be adjusted automatically. For example, the failure threshold can be automatically adjusted to three consecutive failure after two attempted failure in twenty four hour time period. In some examples, failed events can be monitored and stamped with a failed event stamp. For example, failed event in first twenty four hour can have a first failed event stamp, and failed event in forty-eight hours can have a second failed event stamp. First event stamp and second event stamp can be different from each other for monitoring purpose. In some examples, medium 202 can store instructions executable by a processor to trigger a password based authentication in response to the quantity of attempted failures exceeding a failure threshold. In some examples, the medium 202 can store instructions executable by a processor to inactivate the device's account for a threshold period of time.

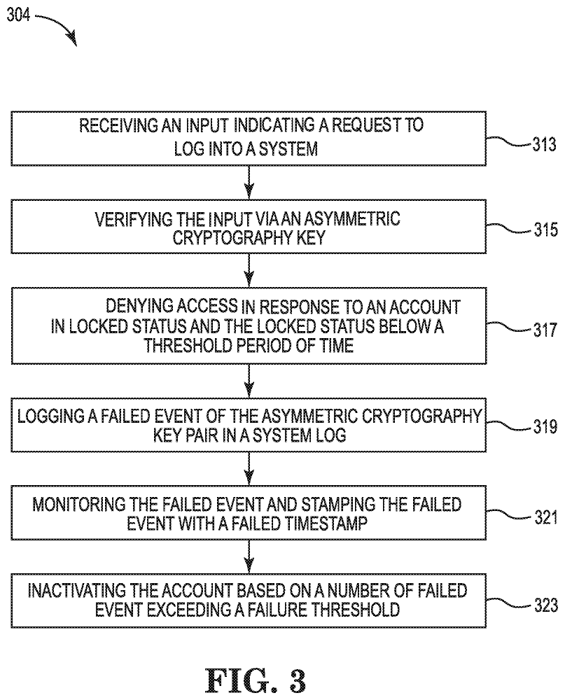

FIG. 3 illustrates a diagram of an example method 304 consistent with the present disclosure. Method 304 can be performed by a processor (e.g., processor 101, described in connection with FIG. 1) and a memory resource (e.g., memory resource 103 described in connection with FIG. 1).

At 313, the example method 304 can include receiving an input from a device indicating a request to log into a system. In some examples, the system can be analogous to authentication server system 100 described in connection with FIG. 1. In some examples, input from the device can be a digital signature, or a passphrase entered by the device. In some examples, input by the device can be encrypted data. In some examples, the input from the device can be decrypted using an authentication agent.

The authentication agent can be a separate program which can hold decrypted private keys and generate digital signatures on request from the device and/or a server. In some examples, when an account is accessed by a device, the device's private key is loaded into the server. For the remainder of the session, the device can start the authentication agent automatically to generate digital signatures. As the device exits the account, the authentication agent can shut down automatically without storing the device's decrypted private key on the server disk. In some examples, the authentication agent can decrypt the private keys.

At 315, the example method 304 can include verifying the input using an asymmetric cryptography key. As described herein, the public key in the asymmetric cryptography key pair can be shared with unauthorized devices, servers, and systems. The private key of the asymmetric cryptography key can be kept secret by not sharing with unauthorized devices. Either of the public and/or private keys can be used to encrypt a message. In some examples, the opposite key from the private and/or private key used to encrypt the message can be used for decryption. In some examples, an authentication server system, such as the authentication server system 100, can verify the input from the device by verifying that a holder of the public key sent an encrypted message, and that a paired private key can decrypt the message encrypted with a public key. In some examples, verification can be done by verifying digital signatures and/or a passphrase, as described herein.

At 317, the example method 304 can include denying access to the device. The example method 304 can include denying access to the device in response to an account being in locked status and the locked status of the account occurring less than a threshold period of time. For example, the example method 304 can include receiving and verifying an input from a device indicating a request to log into a system. At 317, the example method 304 can include determining that the account is already in locked status, and the locked status has occurred for less than a threshold period of time. In response to that determination, the device's access can be denied. For example, a device can be in locked status for ten minutes. If the threshold period of time for the locked status is fifteen minutes, the device's access can be denied as the locked status is less than the threshold period of fifteen minutes.

At 319, the example method 304 can include logging a failed event of the asymmetric cryptography key pair in a system log. As described herein, the term “system log” refers to a log file that records events that occur in a system. In some examples, a failed event of the asymmetric cryptography key pair can include a private key's failure to decrypt a message encrypted with the paired public key. In some examples, a failed event of the asymmetric cryptography key pair can include the public key's failure to decrypt a message encrypted with the paired private key. In some examples, by using the asymmetric cryptography key pair, a device can combine a message with a private key to create a short digital signature within the message. In such examples, the device with the corresponding public key can combine a message, for example, a known digital signature, within the device's private key. The known public key can verify whether the digital signature is valid by verifying that the private key of the device was held by the owner/user of the corresponding private key that is being verified . In some examples, the asymmetric cryptography key pair can include a private key to generate digital signatures.

In some examples, at 319, the example method 304 can include logging a failed event of the asymmetric cryptography key pair in a system log. In some examples, the system log can generate a log file based on the failed event information. As described herein, the term “log file” refers to an information file of the communications and/or transactions between a system and the devices of that system. As used herein, the term “information” can, for example, refer to data, addresses, control, management (e.g., statistics) or any combination thereof. For transmission, information may be transmitted as a message, which may, for example, be in the form of a collection of bits in a predetermined format. In some examples, the log file can capture the type, content, or time of transactions made by a device from a terminal with that system. In some examples, the system can track time using a log file to reactivate the account.

At 321, the example method 304 can include monitoring the failed event and marking the failed event with a failed timestamp. As described herein, the term “time stamp” refers to a sequential numbering of events that is recorded by a computer. A system can accurately maintain a current time, calibrated to minute fractions of a second using the time stamp. Such calibration can make it possible for network systems and applications to communicate.

In some examples, the failed events can be monitored using a time stamp that indicates a sequential numbering of failed events. In some examples, the failed time stamp can include a current time of the failed event recorded by the system. In some examples, the system can accurately keep accounts inactivated for the threshold period of time, as described herein. In some examples, the time stamp can be a digital time stamp. In some examples, the time stamp can be used by the system to reactivate the account in response to exceeding the threshold period of time.

At 323, the example method 304 can include inactivating the account based on a number of failed events exceeding a failure threshold. In some examples, the inactivated account remains inactive for the threshold period of time. In some examples, the failure threshold can be set to a quantity of ten consecutive failures. In some examples, the failure threshold can be adjusted manually by a device, and or a user. In some examples, the failure threshold can be adjusted automatically. In some examples, failed events can be monitored and stamped with a failed event stamp. In some examples, the quantity of attempted failures exceeding a failure threshold can trigger password based authentication.

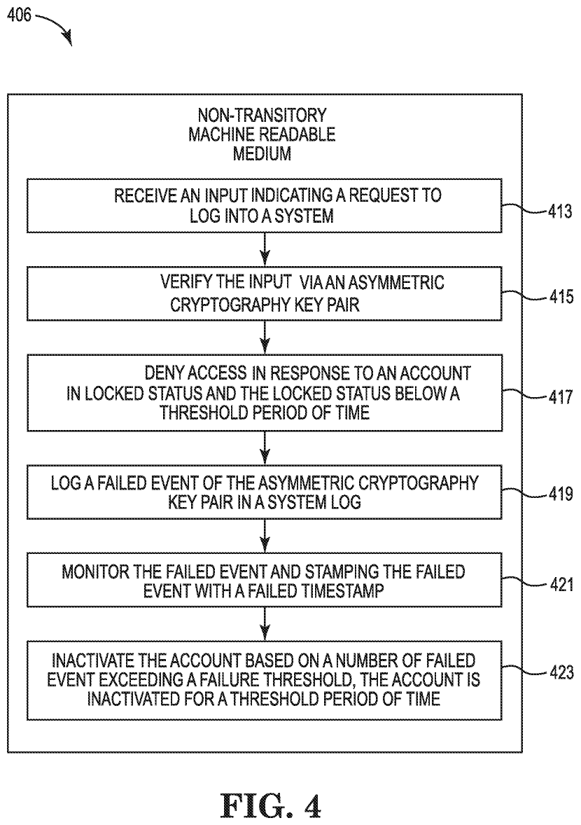

FIG. 4 illustrates an example of a non-transitory machine readable medium 406 consistent with the present disclosure. The non-transitory machine readable medium 406 can execute instructions 413, 415, 417, 419, 421 and 423 using a processor (such as processor 101 illustrated in FIG. 1). The processor can execute instructions stored on the non-transitory machine readable medium 406. The non-transitory machine readable medium 406 can be any type of volatile or non-volatile memory or storage, such as random access memory (RAM), flash memory, read-only memory (ROM), storage volumes, hard disk, or a combination thereof

The example medium 406 can store instructions 413 executable by a processor to receive an input from a device indicating a request to log into a system (such as authentication server system 100, as described in FIG. 1). In some examples, input from the can be a digital signature, or a passphrase entered by a device. In some examples, input can be encrypted data. In some examples, the input can be decrypted using an authentication agent.

The example medium 406 can store instructions 415 executable by a processor to verify the input from the device using an asymmetric cryptography key pair decryption. In some examples, an authentication server system, such as the authentication server system 100, can verify the input from the device by verifying that a holder of the public key sent an encrypted message, and that a paired private key can decrypt the message encrypted with the public key.

The example medium 406 can store instructions 417 executable by a processor to deny access to the device in response to an account being in a locked status and the locked status of the account occurring for less than a threshold period of time. For example, medium 406 can store instructions 417 to determine that an account is already in locked status, and the locked status has occurred for less than a threshold period of time. In response to that determination, the device can be denied access to the device's account. For example, the device can be in the locked status for ten minutes. If the threshold period of time for the locked status is fifteen minutes, the device's access can be denied as the locked status has occurred for less than the threshold period of fifteen minutes.

The example medium 406 can store instructions 419 executable by a processor to log a failed event of the asymmetric cryptography key pair in a system log. In some examples, the system log can generate a log file to capture the type, content, or time of transactions made by a device from a terminal with that system. In some examples, the system can track time using a log file to reactivate the account.

The example medium 406 can store instructions 421 executable by a processor to monitor the failed event and mark the failed event with a failed timestamp. In some examples, the failed events can be monitored using a time stamp that indicates a sequential numbering of failed events. In some examples, the failed time stamps can include a current time of the failed event recorded by the system. In such examples, the system can accurately keep accounts inactivated for the threshold period of time, as described herein. In some examples, the time stamp can be a digital time stamp. In some examples, the time stamp can be used by the system to reactivate the account in response to exceeding the threshold period of time.

The example medium 406 can store instructions 423 executable by a processor to inactivate the account based on a number of failed event exceeding a failure threshold. The account can be inactivated for a threshold period of time. In some examples, the threshold period of time can be fifteen minutes.

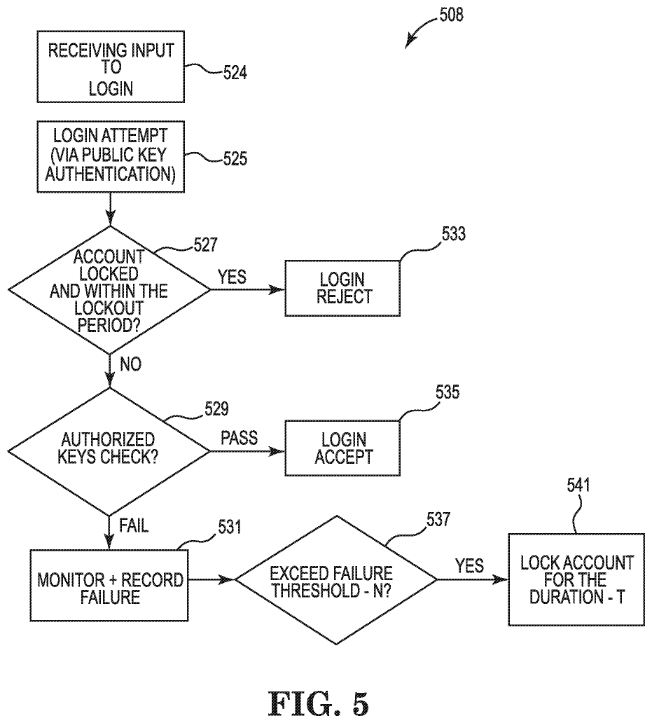

FIG. 5 illustrates an example flowchart of a method 508 for authentication using an asymmetric cryptography key pair consistent with the present disclosure. Method 508 can be utilized to authenticate a device and/or inactivate the device account in an authentication server system.

At 524, the example method 508 can include receiving, at an authentication server system, an input from a device indicating a request to log into an account. At 525, the example method 508 can include verifying the device's input using an asymmetric cryptography key pair. At 527 the example method 508 can include verifying whether the device's account is locked and is within the lockout period. In some examples, in response to determining that the account is in a locked status and the locked status has occurred for less than the threshold period of time, the example method 508 can include verifying the device's authentication. At 529, the example method 508 can include verifying the device's authentication using an asymmetric cryptography key pair. At 535, the example method 508 can include verifying input from the device by verifying that the private key of the asymmetric cryptography key pair can decrypt the message encrypted with the paired public key. In some examples, in response to the private key corresponding to the public key, the device's access to the account can be granted.

At 533, the example method 508 can include accepting the device's login information and allowing the device to access the account in response to determining the device's account is in a locked status and the locked status as occurred for more than the threshold period of time.

At 535, the example method 508 can include, in response to the private key corresponding to the public key, granting the device access to the account. In some examples, in response to the private key not corresponding to the public key, the method can include logging the event as a failed event. At 531, the example method 508 can include monitoring the failed event and marking the failed event with a failed timestamp.

At 537, the example method 508 can include determining whether the number of failed events exceed the failure threshold. At 541, the example method 508 can include inactivating the account for a threshold period of time. The determination is based in response to the server determining a number of failed events have exceeded the failure threshold.

Although the flowchart of FIG. 5 shows a specific order of performance of certain functionalities, method 508 is not limited to that order. For example, some of the functionalities shown in succession in the flowchart may be performed in a different order, may be executed concurrently or with partial concurrence, or a combination thereof.

In the foregoing detailed description of the present disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure and should not be taken in a limiting sense.

What is claimed is:

1. An authentication server system comprising:
a processor; and
a memory resource storing machine readable instructions executable by the processor to:
receive an input from a device indicating a request to log into the system;
verify the input from the device using an asymmetric cryptography key pair;
deny access to the device in response to the input failing to correspond to the asymmetric cryptography key pair; and
inactivate an account of the device based on a number of attempt failures exceeding a failure threshold.

2. The authentication server system of claim 1, wherein the input from the device is verified without an additional authentication verification.

3. The authentication server system of claim 1, wherein the account is inactivated for a threshold period of time.

4. The authentication server system of claim 3, wherein the public key of the asymmetric cryptography key pair is copied to the authentication server system.

5. The authentication server system of claim 1, wherein the input from the device is decrypted using an authentication agent.

6. The authentication server system of claim 5, wherein the authentication agent decrypts the private keys.

7. The authentication server system of claim 3, wherein the public key includes a fingerprint box to generate a fingerprint value.

8. The authentication server system of claim 1, wherein failing to correspond to the asymmetric cryptography key pair includes the private key failing to correspond to the public key.

9. The authentication server system of claim 1, wherein the account is inactivated in response to the private key consecutively failing to correspond to the public key.

10. The authentication server system of claim 1, wherein the number of attempted failures exceeding a failure threshold triggers password based authentication.

11. A method comprising:
receiving an input from a device indicating a request to log into a system;
verifying the input from the device using only an asymmetric cryptography key;
denying access to the device in response to:
an account in locked status; and
the locked status below a threshold period of time;
logging a failed event of the asymmetric cryptography key pair in a system log;
monitoring the failed event and stamping the failed event with a failed timestamp; and
inactivating the account based on a number of failed event exceeding a failure threshold.

12. The method of claim 11, wherein the input is verified without using passphrase verification.

13. The method of claim 11, wherein the inactivated account remains inactive for the threshold period of time.

14. The method of claim 11, wherein the failed timestamp is a current time of the failed event recorded by the system.

15. The method of claim 11, wherein the timestamp is a digital timestamp.

16. The method of claim 11, wherein the system log generates a log file based on the failed event information.

17. The method of claim 11, wherein the system tracks time to reactivate the account.

18. A non-transitory machine-readable medium storing instructions executable by a processor to:
receive an input from a device indicating a request to log into a system;
verify the input from the device using only an asymmetric cryptography key pair and without using passphrase verification;
deny access to the device in response to:
an account in locked status; and
the locked status below a threshold period of time;
log a failed event of the asymmetric cryptography key pair in a system log;
monitor the failed event and stamping the failed event with a failed timestamp; and
inactivate the account based on a number of failed event exceeding a failure threshold, wherein the account is inactivated for a threshold period of time.

19. The medium of claim 18, wherein the threshold period of time is fifteen minutes.

20. The medium of claim 18, wherein the asymmetric cryptography key includes a private key to generate digital signatures.
